(19) United States
(12) Patent Application Publication
(10) Pub. No.: US 2021/0370309 A1
(43) Pub. Date: Dec. 2, 2021

(54) Alloys of Black Phosphorus by Ball Milling Techniques

(71) Applicant: BOISE STATE UNIVERSITY, Boise, ID (US)

(72) Inventors: Samuel Pedersen, Boise, ID (US); Brian Jaques, Meridian, ID (US); David Estrada, Boise, ID (US); Joshua Wood, Oak Park, IL (US); Chad Husko, Chicago, IL (US); Florent Muramutsa, Boise, ID (US)

(21) Appl. No.: 16/930,958

(22) Filed: Jul. 16, 2020

Related U.S. Application Data
(60) Provisional application No. 63/033,647, filed on Jun. 2, 2020.

(51) Int. Cl. B02C 17/08; B02C 23/18; B02C 23/36; C01B 25/00

(52) U.S. Cl. CPC B02C 17/08; B02C 23/18; B02C 23/36; C01P 2002/82; C01P 2002/54; C01P 2006/40; C01P 2002/72; C01B 25/003

(57) ABSTRACT

Methods for forming black phosphorus alloys and exfoliating black phosphorus alloys. A method for forming black phosphorus alloys includes providing phosphorus inside a vessel and providing an element inside the vessel. Media is provided inside the vessel and the phosphorus, the element, and the media are sealed under a gas within the vessel. The phosphorus and the element are mechanically milled with the media to produce black phosphorus that is covalently bonded with the element. A method for exfoliating a black phosphorus alloy includes mixing a milled black phosphorus alloy with a solvent and mixing a milled black phosphorus alloy with a solvent. The milled black phosphorus alloy and solvent mixture are then extracted from the milling apparatus, which may be a planetary ball mill, a vibratory mill, a tumbler ball mill, a mixer mill, a rod mill, an attrition mill, or a shaker mill.

### CROSS REFERENCE TO RELATED APPLICATION

The present application claims the benefit of priority under 35 U.S.C. § 119 to U.S. Provisional Patent Application No. 63/033,647, filed Jun. 2, 2020, entitled “ALLOYS OF BLACK PHOSPHORUS BY BALL MILLING TECHNIQUES,” the disclosure of which is incorporated herein by reference in its entirety.

### FIELD OF THE DISCLOSURE

The examples described herein relate to methods for forming black phosphorus alloys and exfoliating black phosphorus alloys.

### BACKGROUND

### Description of the Related Art

Black phosphorus may be used in various semiconductor, optoelectronic, and photovoltaic applications. It is well known that an allotrope of phosphorus, such as red phosphorus, may be milled to form black phosphorus. Red phosphorus is more readily available than black phosphorus. One conventional method of forming black phosphorus includes the conversion of red phosphorus by sealing a few grams inside a vacuum tube along with a refluxed mixture of tin, gold, and iodine and heating to the vacuum tube to 600° C. for 2-3 days. However, the failure to maintain the high-purity vacuum and precise cooling rate can result in explosive white phosphorus which limits scalability.

All known mass production methods of black phosphorus suffer from low conversion yields with poor flake size distributions. Commercial black phosphorus may be obtained through furnace methods at a cost of approximately $500 per gram. In contrast, 1 kilogram of red phosphorus can be obtained commercially for approximately $200, which is a cost per gram of $0.20. The lower cost of red phosphorus tends to encourage milling red phosphorus to form black phosphorus.

Milled black phosphorus is an intrinsic p-type material, which means that its holes are the majority charge carrier for current as contrasted against an n-type material, which means that the material's electrons are the majority charge carrier for current. In various applications it may be necessary to use a n-type material to produce a p-n junction. The electrical conductivity of milled black phosphorus may not be sufficient for all applications. Other disadvantages may exist.

### SUMMARY

It may be beneficial to improve the electrical and opto-electrical properties of milled black phosphorus. The present disclosure is directed to methods for forming black phosphorus alloys and exfoliating black phosphorus alloys.

One example of the present disclosure is a method for forming black phosphorus. The method includes providing phosphorus inside a vessel and providing an element inside the vessel. The method includes providing media inside the vessel and sealing the phosphorus, the element, and the media under a gas within the vessel. The method includes mechanically milling the phosphorus and the element with the media to produce black phosphorus, wherein the black phosphorus comprises black phosphorus covalently bonded with the element.

The phosphorus may be an allotrope of phosphorus. The allotrope of phosphorus may be white phosphorus, black phosphorus, or red phosphorus. The phosphorus may be powder, single crystals, or lumps. The gas may be air, an inert gas, or a non-reactive gas. The inert gas may be argon or helium. The non-reactive gas may be nitrogen or carbon dioxide. The media may be stainless steel balls, stainless steel bearings, ceramic balls, ceramic cylinders, or ceramic satellites.

The element may be an n-type dopant. The n-type dopant may be sulfur or tellurium. The element may be a p-type dopant. The p-type dopant may be tin. The vessel may be a planetary ball mill. The method may include exfoliating the black phosphorous. The method may include mixing the black phosphorus covalently bonded with the element with isopropanol. The method may include milling the black phosphorus isopropanol mixture. The method may include extracting the black phosphorus isopropanol mixture. Exfoliating the black phosphorus may include mixing the black phosphorus covalently bonded with an element with a solvent and exfoliating the black phosphorus and solvent mixture with an ultrasonic probe tip.

One example of the present disclosure is an exfoliating method. The method includes mixing a milled black phosphorus alloy with a solvent. The method includes mixing a milled black phosphorus alloy with a solvent. The method includes extracting the milled black phosphorus alloy and solvent mixture from the milling apparatus. The milling apparatus may be a planetary ball mill, a vibratory mill, a tumbler ball mill, a mixer mill, a rod mill, an attrition mill, or a shaker mill.

The method may include separating layers of exfoliated milled black phosphorus alloy. Separating layers of exfoliated milled black phosphorus alloy may include centrifuging the exfoliated milled black phosphorus alloy. Centrifuging the exfoliated milled black phosphorus alloy may include density gradient centrifuging the exfoliated milled black phosphorus alloy. The method may include sealing the exfoliated milled black phosphorus alloy into a tube containing a linear density gradient solution and centrifuging the tube. The solvent may be a polar protic solvent, a dipolar aprotic solvent, a non-polar solvent, or an inorganic solvent. The polar protic solvent may be isopropanol, water, acetic acid, methanol, ethanol, n-propanol, or n-butanol. The dipolar aprotic solvent is acetone, ethyl acetate, dimethyl sulfoxide, acetonitrile, or dimethylformamide. The non-polar solvent may be carbon tetrachloride, benzene, diethyl ether, hexane, or methylene chloride. The inorganic solvent may be anhydrous ammonia.

One example of the present disclosure is an exfoliating method. The method includes mixing a milled black phosphorus alloy with a solvent. The method includes exfoliating the milled black phosphorus alloy and solvent mixture with an ultrasonic probe tip. The solvent may be a polar protic solvent, a dipolar aprotic solvent, a non-polar solvent, or an inorganic solvent.

### BRIEF DESCRIPTION OF THE DRAWINGS

FIG. 1 is a flow chart of an embodiment of a method for forming black phosphorus.

FIG. 2 is a flow chart of an embodiment of an exfoliation method.

FIG. 3. is a flow chart of an embodiment of an exfoliation method.

FIG. 4. is a schematic showing a portion of a vessel containing media and milled black phosphorus.

FIG. 5 is a chart indicating the photoluminescent properties of milled black phosphorus formed by the methods disclosed herein.

FIG. 6 is a chart that indicates structures of various elements and black phosphorus alloys have different crystal structures.

FIG. 7 is a chart depicting x-ray photoelectron spectroscopy of black phosphorus and alloys of black phosphorus and tin (Sn), black phosphorus and tellurium (Te), and black phosphorus and sulfur (S).

FIG. 8 is a chart depicting x-ray photoelectron spectroscopy of black phosphorus and sulfur (S) alloy.

FIG. 9 is a chart depicting x-ray photoelectron spectroscopy of black phosphorus and tin (Sn) alloy and black phosphorus and tellurium (Te) alloy.

FIG. 10 is a chart depicting the Raman spectra of milled black phosphorus and exfoliated milled black phosphorus.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure as defined by the appended claims.

### DETAILED DESCRIPTION

A black phosphorus alloy may be formed by milling phosphorus in a vessel or milling apparatus with an element added to the vessel. The phosphorus may be an allotrope of phosphorus, such as white phosphorus, black phosphorus, or red phosphorus. The phosphorus may be inserted into the vessel in various forms, such as but not limited to, powder, single crystals, or lumps. The vessel is sealed with the phosphorus, element and media under a gas. The gas may be air, an inert gas, or a non-reactive gas. The inert gas may be, but is not limited to, argon or helium. The non-reactive gas may be, but is not limited to, nitrogen or carbon dioxide. Various media may be used such as, but not limited to, stainless steel balls, stainless steel bearings, ceramic balls, ceramic cylinders, or ceramic satellites. The milling media may consist of different materials, such as, but not limited to, steel or ceramic and may consist of different sizes, shapes, and/or geometries, such as, but not limited to, spherical, cylindrical, and/or satellites.

The mixture of phosphorus and the element is milled within the vessel, or milling apparatus, until a black phosphorus alloy is formed within the vessel. Various methods of milling and media may be used. For example, the vessel, or milling apparatus, may be a planetary ball mill, a vibratory mill, a tumbler ball mill, a mixer mill, a rod mill, an attrition mill, a shaker mill, magneto-ball mill, or the like. The time and/or process to mill the black phosphorus alloy is dependent on various variables such as, but not limited to, the type of phosphorus, the form of phosphorus, the media used, the revolutions per minute of the milling apparatus, the element used, and the like. In one example, 1 gram of red phosphorus and 0.1 grams of tellurium are inserted into a 250 mL stainless steel vessel with thirty (30) 10 mm diameter stainless steel round balls. The red phosphorus and tellurium are milled with the stainless steel round balls for 1-10 hours at 400-600 revolutions per minute (rpm) to produce a black phosphorus alloy with tellurium.

Various elements may be used to form a black phosphorus alloy by milling phosphorus with an element as would be appreciated by one of ordinary skill in the art having the benefit of this disclosure. For example, the element may be an n-type dopant, such as but not limited to, sulfur or tellurium. The element may be a p-type dopant, such as but not limited to, tin. The element used and the amount of element added to phosphorus may change the time and/or rpm necessary to form a black phosphorus alloy as would be appreciated by one of ordinary skill in the art having the benefit of this disclosure.

After the black phosphorus alloy is formed, the black phosphorus alloy may be exfoliated to form black phosphorus in a single layer, a few layers, or the like. Exfoliated black phosphorus alloy may be preferred depending on the electronic and/or opto-electronic application in which the black phosphorus alloy is to be used. Various methods of exfoliation may be used to exfoliate a black phosphorus alloy as would be appreciated by one of ordinary skill in the art having the benefit of this disclosure. For example, the black phosphorus alloy may be mixed with a solvent and the mixture may be milled in a milling apparatus. The black phosphorus alloy and solvent mixture may then be extracted from the milling apparatus. The black phosphorus may be mixed with a solvent and the mixture may be exfoliated with an ultrasonic probe tip.

Exfoliated black phosphorus alloy may be separated into layers. By exfoliation, it is understood that this consists of separating the crystals of black phosphorus into atomically thin sheets consisting of a single puckered structure of black phosphorus. The “layers” can consist of a single monolayer of black phosphorus, or any number of layers held together. The size of such layers may be nanometers in one or more dimensions and may be referred to as quantum dots, or nanosheets. Various mechanisms may be used to separate the exfoliated black phosphorus alloy into layers depending on the application. For example, the exfoliated black phosphorus alloy may be centrifuged. In one example, centrifuging the exfoliated black phosphorus alloy may include density gradient solution with black phosphorus alloy. The exfoliated black phosphorus alloy may be seal into a tube containing a linear density gradient solution and the tube may then be centrifuged.

Various solvents may be used when exfoliating a black phosphorus alloy. For example, the solvent may be, but is not limited to, a polar protic solvent, a dipolar aprotic solvent, a non-polar solvent, an inorganic solvent, or the like. The polar protic solvent may be, but is not limited to, isopropanol, water, acetic acid, methanol, ethanol, n-propanol, n-butanol, or the like. The dipolar aprotic solvent may be, but is not limited to, acetone, ethyl acetate, dimethyl sulfoxide, acetonitrile, dimethylformamide, or the like. The non-polar solvent may be, but is not limited to, carbon tetrachloride, benzene, diethyl ether, hexane, methylene chloride, or the like. The inorganic solvent, may be, but is not limited to, anhydrous ammonia or the like.

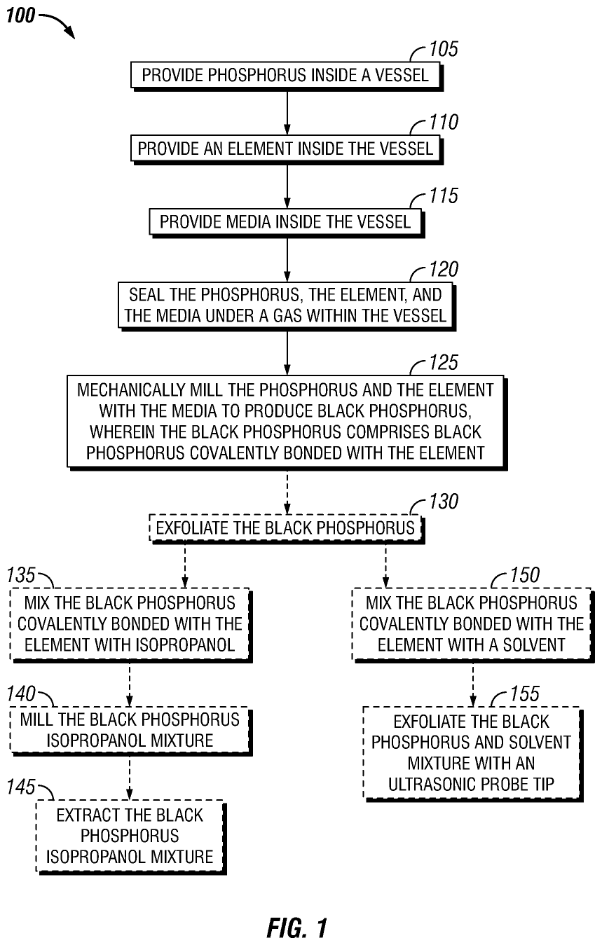

FIG. 1 is a flow chart for an embodiment of a method 100 for forming black phosphorus. The method 100 includes providing phosphorus inside a vessel, at 105. The phosphorus may be an allotrope of phosphorus. For example, the phosphorus may be red phosphorus. The phosphorus may be in various different forms such as, but not limited to, powder, crystals, and/or lumps.

The method 100 includes providing an element inside the vessel, at 110. The element may be various elements. For example, the element may be an n-type dopant or a p-type dopant. The element may be an n-type dopant such as, but not limited to, oxygen, sulfur, selenium, tellurium, or the like. The element may be a p-type dopant, such as, but not limited to, boron, carbon, aluminum, silicon, gallium, germanium, indium, tin, thallium, lead, or the like. The element may be, but is not limited to, titanium, iron, cobalt, nobelium, copper, zinc, antimony, bismuth, arsenic, nitrogen, or the like. The method 100 includes providing media inside the vessel, at 115. Various media may be provided in the vessel. For example, the media may be, but is not limited to, stainless steel balls, stainless steel bearings, ceramic balls, ceramic cylinders, or ceramic satellites.

The method 100 includes sealing the phosphorus, the element, and the media under a gas within the vessel, at 120. The gas may be air, an inert gas, a non-reactive gas, or the like. The gas may be, but is not limited to, argon, helium, carbon dioxide, nitrogen, or the like. The method 100 includes mechanically milling the phosphorus and the element with the media to produce black phosphorus, wherein the black phosphorus comprises black phosphorus covalently bonded with the element, at 125.

The method 100 may include exfoliating the black phosphorus, at 130. The method 100 may include mixing the black phosphorus covalently bonded with the element with isopropanol, at 135. The method 100 may include milling the black phosphorus isopropanol mixture, at 140. The method 100 may include extracting the black phosphorus isopropanol mixture, at 145. The method 100 may include mixing the black phosphorus with a solvent, at 150. The method 100 may include exfoliating the black phosphorus and solvent mixture with an ultrasonic probe tip, at 155.

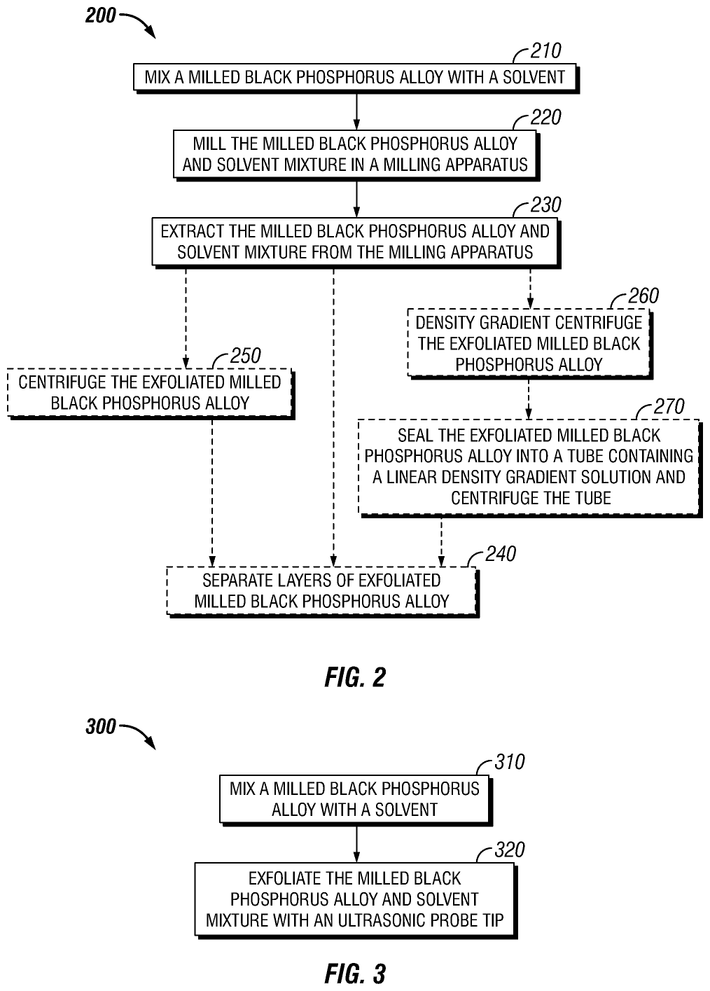

FIG. 2 is a flow chart for an embodiment of a method 200 for exfoliating black phosphorus. The method 200 includes mixing a milled black phosphorus alloy with a solvent, at 210. The solvent may be, but is not limited to, a polar protic solvent, a dipolar aprotic solvent, a non-polar solvent, an inorganic solvent, or the like. The polar protic solvent may be, but is not limited to, isopropanol, water, acetic acid, methanol, ethanol, n-propanol, n-butanol, or the like. The dipolar aprotic solvent may be, but is not limited to, acetone, ethyl acetate, dimethyl sulfoxide, acetonitrile, dimethylformamide, or the like. The non-polar solvent may be, but is not limited to, carbon tetrachloride, benzene, diethyl ether, hexane, methylene chloride, or the like. The inorganic solvent, may be, but is not limited to, anhydrous ammonia or the like

The method includes milling the milled black phosphorus alloy and solvent mixture in a milling apparatus, at 220. The milling apparatus may be a planetary ball mill, a vibratory mill, a tumbler ball mill, a mixer mill, a rod mill, an attrition mill, a shaker mill, or the like. The method 200 includes extracting the milled black phosphorus alloy and solvent mixture from the milling apparatus, at 230. The method 200 may include separating layers of exfoliated milled black phosphorus alloy, at 240. Various methods may be used to separate the layers of exfoliated milled black phosphorus alloy. The method 200 may include centrifuging the exfoliated milled black phosphorus alloy, at 250. The method 200 may include density gradient centrifuging the exfoliated milled black phosphorus alloy, at 260. The method 200 may include sealing the exfoliated milled black phosphorus alloy into a tube containing a linear density gradient solution and centrifuging the tube, at 270.

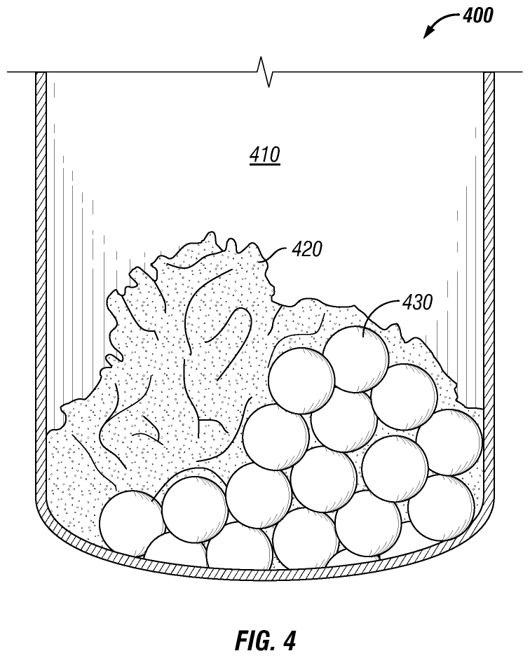

FIG. 3. is a flow chart of one embodiment of method 300 of exfoliating black phosphorus alloy. The method 300 includes mixing the black phosphorus alloy with a solvent, at 310. The method 300 includes exfoliating the milled black phosphorus alloy and solvent mixture with an ultrasonic probe tip, at 320. FIG. 4 is a schematic of a portion of a system 400 that includes a vessel 410 with a black phosphorus alloy 420 formed by milling over an extended period of time with media 430.

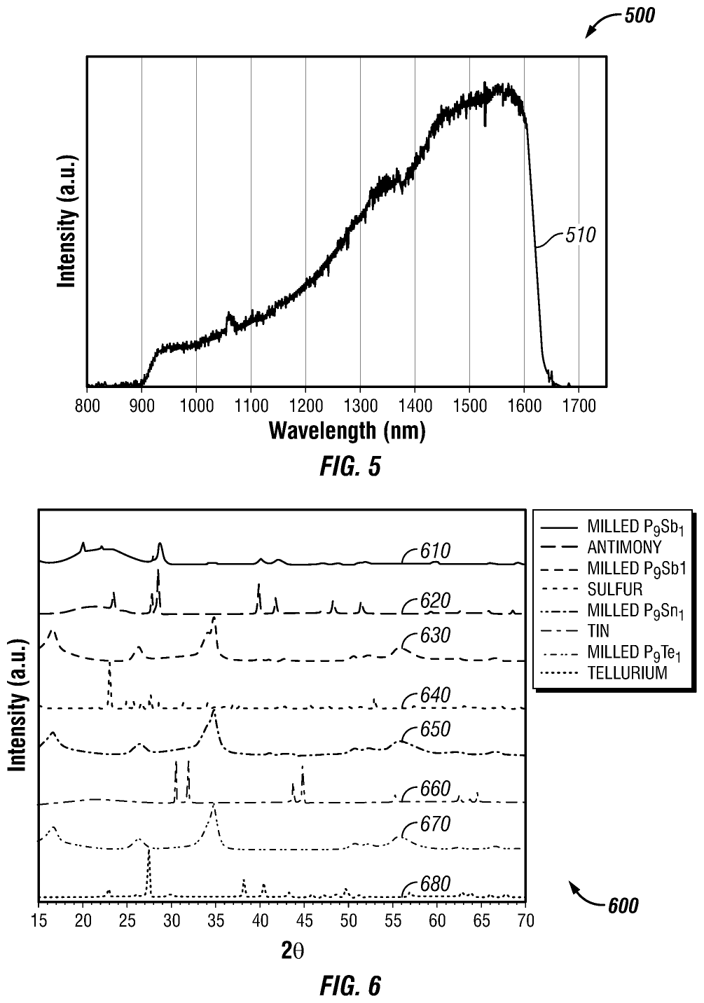

FIG. 5 shows a chart 500 indicating photoluminescent properties 510 of milled black phosphorus formed by the methods disclosed herein. The milled black phosphorus formed by the methods disclosed herein may emit light across a broad spectrum 900 nm to 1600 nm as a function of number of atomic layers of the black phosphorus that is present. The broad spectrum range of 900 nm to 1600 nm may shift slightly below 900 nm and/or above 1600 nm depending on the element that is covalently bonded with the black phosphorus during the milling process.

FIG. 6 is a chart 600 that indicates structures of various elements and black phosphorus alloys have different crystal structures. For example, the crystal structure for antimony, indicated by line 620, differs from the crystal structure for the milled black phosphorus antimony alloy, indicated by line 610. This indicates that an alloy is formed by milling rather than the milled black phosphorus generated from the milling process being just a mixture of black phosphorus and antimony. Likewise, the crystal structure for sulfur, indicated by line 640, differs from the crystal structure of milled black phosphorus and sulfur alloy, indicated by line 630. Likewise, the crystal structure for tin, indicated by line 660, differs from the crystal structure of milled black phosphorus and tin alloy, indicated by line 650. Likewise, the crystal structure for tellurium, indicated by line 680, differs from the crystal structure of milled black phosphorus and tellurium alloy, indicated by line 670.

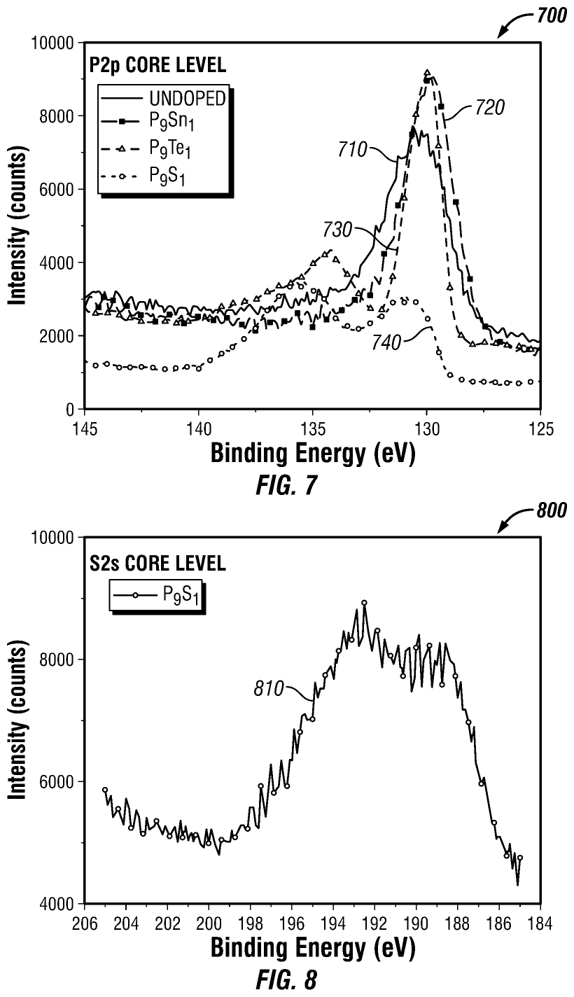

FIG. 7 is a chart 700 depicting x-ray photoelectron spectroscopy of black phosphorus 710 and alloys of black phosphorus and tin (Sn) 720, black phosphorus and tellurium (Te) 730, and black phosphorus and sulfur (S) 740. The differences in the x-ray photoelectron spectroscopy indicates that the black phosphorus is covalently bonded to the elements (i.e., tin, sulfur, and tellurium) after the milling process rather than simply forming a mixture of black phosphorus and the element.

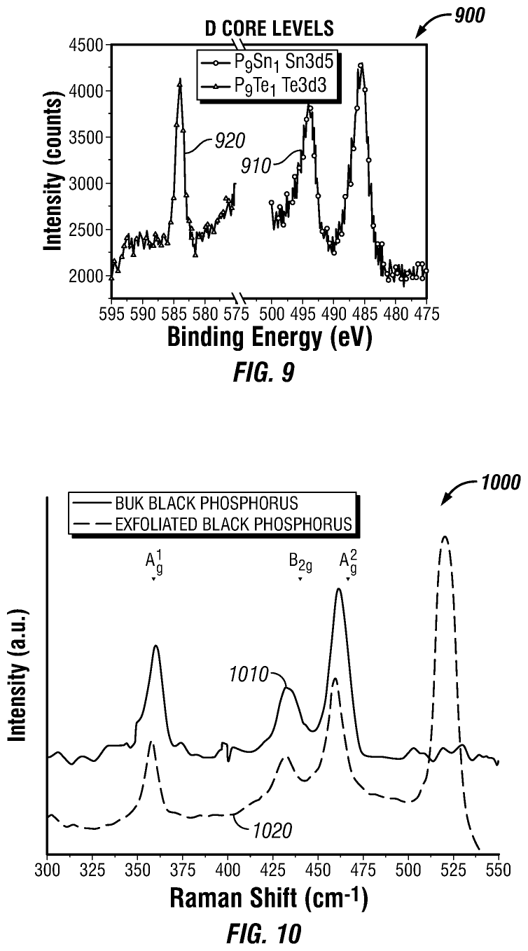

FIG. 8 is a chart 800 depicting x-ray photoelectron spectroscopy of black phosphorus and sulfur (S) alloy 810. FIG. 9 is a chart 900 depicting x-ray photoelectron spectroscopy of black phosphorus and tin (Sn) alloy 910 and black phosphorus and tellurium (Te) alloy 920. The differences in the x-ray photoelectron spectroscopy indicate that the element added to phosphorus and milled to create a black phosphorus alloy with the element being covalently bonded with the black phosphorus.

FIG. 10 is a chart 1000 depicting the Raman shift between milled black phosphorus 1010 and exfoliated milled black phosphorus 1020. The chart 1000 indicates that the exfoliation process on milled black phosphorus does not destroy the electrical-optical and/or optical properties of the milled black phosphorus.

Although this disclosure has been described in terms of certain embodiments, other embodiments that are apparent to those of ordinary skill in the art, including embodiments that do not provide all of the features and advantages set forth herein, are also within the scope of this disclosure. Accordingly, the scope of the present disclosure is defined only by reference to the appended claims and equivalents thereof.

What is claimed is:

1. A method for forming black phosphorus comprising:
providing phosphorus inside a vessel;
providing an element inside the vessel;
providing media inside the vessel;
sealing the phosphorus, the element, and the media under a gas within the vessel; and
mechanically milling the phosphorus and the element with the media to produce black phosphorus, wherein the black phosphorus comprises black phosphorus covalently bonded with the element.

2. The method of claim 1, wherein the phosphorus is an allotrope of phosphorus.

3. The method of claim 2, wherein the allotrope of phosphorus is white phosphorus, black phosphorus, or red phosphorus.

4. The method of claim 2, wherein the phosphorus is a powder, single crystals, or lumps.

5. The method of claim 1, wherein the gas is air, an inert gas, or a non-reactive gas.

6. The method of claim 5, wherein the inert gas is argon or helium.

7. The method of claim 5, wherein the non-reactive gas is nitrogen or carbon dioxide.

8. The method of claim 1, wherein media comprises stainless steel balls, stainless steel bearings, ceramic balls, ceramic cylinder, or ceramic satellites.

9. The method of claim 1, wherein the element is an n-type dopant.

10. The method of claim 9, wherein the n-type dopant is sulfur or tellurium.

11. The method of claim 1, wherein the element is a p-type dopant.

12. The method of claim 11, wherein the p-type dopant is tin.

13. The method of claim 1, wherein the vessel is a planetary ball mill.

14. The method of claim 1, further comprising exfoliating the black phosphorous.

15. The method of claim 14, wherein exfoliating the black phosphorus further comprises:
mixing the black phosphorus covalently bonded with the element with isopropanol;
milling the black phosphorus isopropanol mixture; and
extracting the black phosphorus isopropanol mixture.

16. The method of claim 14, wherein exfoliating the black phosphorus further comprises:
mixing the black phosphorus covalently bonded with the element with a solvent; and
exfoliating the black phosphorus and solvent mixture with an ultrasonic probe tip.

17. An exfoliating method comprising:
mixing a milled black phosphorus alloy with a solvent;
milling the milled black phosphorus alloy and solvent mixture in a milling apparatus; and
extracting the milled black phosphorus alloy and solvent mixture from the milling apparatus.

18. The method of claim 17, wherein the milling apparatus is a planetary ball mill, a vibratory mill, a tumbler ball mill, a mixer mill, a rod mill, an attrition mill, or a shaker mill.

19. The method of claim 17, comprising separating layers of exfoliated milled black phosphorus alloy.

20. The method of claim 19, wherein separating layers of exfoliated milled black phosphorus alloy comprises centrifuging the exfoliated milled black phosphorus alloy.

21. The method of claim 20, wherein centrifuging the exfoliated milled black phosphorus alloy further comprises density gradient centrifuging the exfoliated milled black phosphorus alloy.

22. The method of claim 21, wherein density gradient centrifuging the exfoliated milled black phosphorus alloy further comprises sealing the exfoliated milled black phosphorus alloy into a tube containing a linear density gradient solution and centrifuging the tube.

23. The method of claim 17, wherein the solvent is a polar protic solvent, a dipolar aprotic solvent, a non-polar solvent, or an inorganic solvent.

24. The method of claim 23, wherein the polar protic solvent is isopropanol, water, acetic acid, methanol, ethanol, n-propanol, or n-butanol.

25. The method of claim 23, wherein the dipolar aprotic solvent is acetone, ethyl acetate, dimethyl sulfoxide, acetonitrile, or dimethylformamide.

26. The method of claim 23, wherein the non-polar solvent is carbon tetrachloride, benzene, diethyl ether, hexane, or methylene chloride.

27. The method of claim 23, wherein the inorganic solvent is anhydrous ammonia.

28. An exfoliating method comprising:
mixing a milled black phosphorus alloy with a solvent; and
exfoliating the milled black phosphorus alloy and solvent mixture with an ultrasonic probe tip.

29. The method of claim 28, wherein the solvent is a polar protic solvent, a dipolar aprotic solvent, a non-polar solvent, or an inorganic solvent.
